(19) United States
(12) Patent Application Publication
(10) Pub. No.: US 2002/0075504 A1
(43) Pub. Date: Jun. 20, 2002

(54) Method and apparatus for automatically indexing a document with tabbed sheets

(76) Inventors: Sergio Fernandez, Boise, ID (US); Marcelo Funes-Gallanzi, London (GB)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/738,047

(22) Filed: Dec. 15, 2000

Related U.S. Application Data
(60) Provisional application No. 60/172,359, filed on Dec. 15, 1999.

(51) Int. Cl. G06F 15/00; G06K 1/00

(52) U.S. Cl. 358/1.15; 358/1.12

(57) ABSTRACT

In a copier or printer, automatically providing tabbed sheets in the output of the copier or printer, with an integral, on-line, tab appending system. A selected tab may be appended on any selected sheet being fed through the regular paper path of a xerographic or other copier or printer. This may be done by registering the leading edge of the selected sheet, and then appending to it tab, at a user-selected position. The tab position is specified by the user as part of editing or processing a document. This is information is transmitted to the tab appending apparatus using existing protocols or by printing, or otherwise affixing, barcode information on the document describing where the tab is to be attached as well as the indicia to be recorded on the tab.

### RELATED APPLICATION

This application claims priority to, and hereby incorporates by reference in its entirety, U.S. Provisional Patent Application No. 60/172,359.

### BACKGROUND OF THE INVENTION

1. Field of the Invention

The invention pertains to the field of document processing systems such as copiers and printers. More particularly, the invention pertains to a system for automatically appending tabs to sheets, which are fed through the regular sheet (i.e., paper) path of a xerographic or other photocopier or printing device.

2. Description of the Related Technology

Along with the increases in speed and capabilities of modem copiers and printers, there has been provided collated output in collated copy sets, and the availability of programming special insert sheets at selected positions in the output copy set. The providing of tabbed sheets into collated copy sheet sets, especially where the tabs are printed by the copier or printer itself, has become a desirable feature.

Different brands of software are currently available for causing laser, ink-jet and other printers and copiers to automatically print desired indicia directly on the tabs of divider sheets. The divider sheets typically are approximately 8¼ inches by eleven inches when folded before printing and unfold to the standard 9 inches by 11 inches after printing. They are typically constructed of medium weight paper reinforced along one edge by an adhered layer of plastic film. This edge may include through-holes for filing the divider sheet in a ring binder. Extending out from the opposite edge is a tab, having a length of about 1¼ inch to 1⅞ inch (or 1⅛ inch to 3¼ inches) and a width of ½ inch. The tab may be reinforced with an adhered layer of plastic film. The tabs on different divider sheets in a set are typically laid out at between three to eight different positions.

The size of a standard divider sheet with a tab, for use in a three-ring notebook containing sheets of pre-punched 8½ by 11 inch notebook paper, is 9 by 11 inches, including the width of the tab. Unfortunately, standard printers or photocopiers usually accept only rectangular sheets of widths not exceeding 8½ inches. Accordingly, there is a need for a method for conveniently printing upon the face and tab portion of a 9 by 11 inch divider using a standard printer or photocopier that has an 8½ inch width restriction.

As used here the term “document” refers to a sheet (original or copy), a plurality of sheets, or an electronic image being printed onto the outputted “copy sheet,” or simply “copy.” Related plural sheets of documents or copies are referred to as a “set.” A “simplex” copy is one having an image and “page” on only one side of the sheet, whereas a “duplex” copy has a “page,” and normally an image on both sides.

Within the past couple of years a new office printer—the Hewlett Packard 4V printer (HP4V)—has been made available. The HP4V printer is a high speed, network shared printer adapted for office use. Unlike prior standard printers, the HP4V printer handles sheets as wide as eleven inches; hence, allowing 8½ by 11 inch sheets to be fed in the landscape direction. Thus, 9 by 11 inch divider sheets with tabs can be fed to the HP4V either tabbed edge or binding edge first. Additionally, currently there is software available that allows the printer to print both along the tab and across the body of the divider sheet in a single pass through the HP4V. While the HP4V has made it possible to use standard sheet dividers with tabs in a printer, a method and apparatus still is not known for automatically and conveniently appending tabs to sheets to be incorporated in copy sets outputted by a standard copier or standard printer

One popular approach to the general problem of tabbing has been to print on a standard 8½ by 11 inch sheet and then adhere a pre-punched spine strip along an edge of the sheet. The sheet can then be inserted into a ring binder. However, this solution is inconvenient for two reasons. First, for assemblies in which the spine strips are entirely separate from the divider sheets, the user must separately store both components; this results in storage areas that become cluttered, and the spine strips can be misplaced as well. Second, the user must very carefully attach the pre-punched spine strip to the divider sheet. If the spine strip is misaligned, the user must reposition the strip or may even need to discard the entire assembly, particularly if a permanent pressure sensitive adhesive is used on the spine. Additionally, this arrangement is not user friendly due to the time it takes to remove a release liner from the spine strip and apply the spine strip to the divider sheet.

An alternative approach involves the use of cutters to form tabs as disclosed in U.S. Pat. No. 4,819,021, where the method was specifically designed for photocopiers. This method provides tabbed sheets in the output of the copier, with an integral, on-line, copy sheet tab cutting system. A selected tab may be cut on any selected sheet being fed through the regular copy sheet (paper) path of a xerographic or other copier or printer.

Another successful approach has been to use index sheets having a dual-side directly machine printable index tab portions, as described in U.S. Pat. No. 6,039,354. In this method, an index sheet or divider that may be accommodated by and directly printed upon by a conventional machine printer is employed. The index sheet includes a main body portion and a foldable index tab portion. The index tab portion is transformable into a configuration that allows the index sheet to pass through a printer. After printing, the index tab portion is transformable into another configuration allowing the tab portion to stand out from the document set wherein the divider sheets have been incorporated. When completed, the index tab portion has back-to-back printable surfaces.

Multiple tabs can also be printed in a single run as described in U.S. Pat. No. 6,132,831. In this method, a printer-compatible, index tabs assembly is used. The assembly includes a carrier sheet recognizable by any of a wide variety of computer compatible printing devices. The carrier sheet has a plurality of self-adhesively secured tabs, each of which is formed from a resilient, durable thin film. The adhesive is formulated to either permanently or releasably adhere to an edge of a sheet of material that is to be tagged, labeled or indexed. After printing, the index tab is transferred from the carrier sheet and positioned with the adhesive securing the index tab to the sheet of material and with the indicia projecting outwardly from the edge for convenient display.

Common printers and copiers may have a thickness restriction, in addition to a width restriction, due to interior clearances and due to the radii of bends in the sheet path. Uneven thickness can cause skewing in the transport of sheets through the printer; additionally, jamming is possible. Hence, it is important to minimize thickness variations. Consequently, page assemblies (such as those described by U.S. Pat. Nos. 6,099,189, 6,071,030 or 6,089,777) are not desirable. Furthermore, when a copier or document feeder jam occurs, job recovery is difficult without mixing up or interrupting the desired order of the tabbed sheets, or printing the wrong titles on the wrong tabs, or not printing the tabs at all, etc. Moreover, careful note must be taken of tabbed sheet position and, since these are typically printed separately, the whole approach is prone to costly mistakes. Therefore there exists a need to print tabbed sheets, at the correct position in the document, as it is being printed, and ideally on standard paper such as “letter” or “A4”.

All references cited herein, and their references, are incorporated in their entireties herein for appropriate teachings of additional or alternative details, features, and other technical background.

### SUMMER OF THE INVENTION

One embodiment of the invention is a method of automatically indexing a document comprising feeding a plurality of untabbed sheets in the sheet path of a sheet handling device; identifying selected ones of the sheets based upon a predefined criteria; and automatically appending a tab to the identified sheets. The sheet handling device may be a printer or photocopier. It is to be recognized that the sheet path may comprise the output receptacle of the sheet handling device. Additionally, automatically appending a tab is performed by a tab appending device controlled by a computing device, wherein the computing device is in communication with a central processing unit of a computer that hosts text editing software, or with a printing device, or a bar code reading device. The method may further comprise identifying a location on the selected sheet where the tab is to be appended. One feature of this embodiment may provided that the location of the tab is determined by software after an analysis of the electronic version of the document. Another feature of this embodiment may be that a user specifies the location of the tab using a software interface. The method may further comprise recording indicia on the tab to be appended to the selected sheet. One aspect of this embodiment may be that one of the predefined criteria is a page number. The method may further comprise identifying a location for appending the tab to the identified sheet, and printing indicia on the tab.

In another embodiment, the invention provides a method of automatically indexing a document comprising feeding a plurality of untabbed sheets in the sheet path of a printing device; identifying selected ones of the sheets based upon a predefined criteria; automatically identifying locations for appending tabs to the identified selected sheets; printing indicia on the tab, wherein the indicia is electronically stored; and appending the tab to the identified selected sheets. The wherein the printing device is a printer or a photocopier. In this embodiment, the sheet path of the printing device may comprise the output receptacle of the printing device. One aspect of this embodiment may be that identifying selected ones of the sheets is performed by a computing device, wherein the computing device is in communication with a central processing unit of a computer that hosts text editing software, or with a printer or photocopier, or with a bar code reading device. The aspect of identifying the location for appending the tab may be determined by software analysis of the electronic version of the document. In another aspect of this embodiment, the indicia is generated with a software interface configured to allow a user to define or modify at least one characteristic of the indicia. One feature of this embodiment may be that the predefined criteria is a page number.

Yet another embodiment of the invention is an apparatus for automatically indexing a document comprising a sheet handling device having a sheet path, wherein the document is fed through the sheet path; a computing device for identifying selected ones of the sheets in the sheet path; a sheet sensor in communication with the computing device; and a tab appending mechanism, controlled by the computing device, for appending a tab to the selected sheet. One aspect of this embodiment may be that the computing device receives instructions from an external computing device having text editing capabilities, or from a printer or photocopier, or from a bar code reading device. Another aspect of this embodiment may be that the tab appending mechanism comprises a tab dispensing mechanism controlled by the computing device. Another feature of this embodiment may be that the tab dispensing mechanism comprises a roll of pre-cut tabs attached to a backing tape. This embodiment may further comprise a device for recording indicia on the tab to be dispensed. The device for recording indicia may comprise a print head and an ink source. One aspect of this apparatus may be that the print head is selected from the group consisting of a laser printing device, an ink-jet printing device, a thermal resistive transfer printing device, and an impact printing device. One feature of this embodiment may be that the apparatus is integrated with the sheet handling components of a printing device. And the printing device may be selected from the group comprising: a printer, a photocopier, and a typewriter. One aspect of this embodiment may be that the apparatus is configured for use as an external accessory for use with a printing device, or that the apparatus is configured for use with the manual feeding of sheets. A feature of this apparatus may be that the computing device receives an indication of the location for appending the tab on the selected sheets. And the indication may be provided by a user utilizing a software interface. The indication could be provided by software analysis of an electronic version of the document, or a user may utilize software configured to allow creation and modification of the indicia.

Another embodiment of the invention is an apparatus for automatically indexing a document comprising a printing device having a sheet path for delivering a document having printed, untabbed sheets; a sheet sensor for detecting sheets in the sheet path of the printing device; a computing device, in communication with the sheet sensor, identifying selected ones of the printed, untabbed sheets; a tab dispensing device, controlled by the computing device, for appending tabs to the identified selected sheets; and a print head, controlled by the computing device and cooperating with the tab dispensing device, for recording indicia on the tabs.

Yet another embodiment of the invention is an apparatus for automatically indexing a document comprising a printing device; means for detecting sheets in the output path of the printing device; means for identifying selected ones of the sheets for receiving a tab, wherein the identifying means communicates electronically with the detecting means; means for indicating locations where the tabs are to be appended to the selected sheets, and for creating and editing indicia to be recorded on the tabs; means for generating and communicating the location and indicia of the tabs to the selecting means; means for recording the indicia on the tabs, wherein the selecting means controls the recording means; and means for appending the tabs to the selected sheets, wherein the selecting means controls the appending means.

### BRIEF DESCRIPTION OF THE DRAWINGS

The above and other aspects, features, and advantages of the invention will be better understood by referring to the following detailed description, which should be read in conjunction with the accompanying drawings, in which:

FIG. 1 is a exploded view of an on-line, tab appending apparatus integrated, for illustrative purposes, with a standard printer.

FIG. 2A is an exploded view of the tab cartridge shown in FIG. 1.

FIG. 2B is a side view of the tab cartridge shown in FIG. 2.

FIG. 3 is a schematic diagram of the structure of the tab roll contained within the tab cartridge of FIG. 2B.

FIG. 4 is a schematic diagram of the electronics, actuators, and feedback sensors used in the apparatus of FIG. 1.

FIG. 5 is a flow chart of the software used to interface text editing or desktop publishing software with the on-line, tab appending apparatus of FIG. 1.

FIG. 6 shows a screen capture image of an exemplary user interface for specifying the page, position and content that is to be printed on a selected tab.

### DETAILED DESCRIPTION OF THE INVENTION

The following detailed description is directed to certain specific embodiments of the invention. However, the invention can be embodied in a multitude of different ways as defined and covered by the claims. In this description, reference is made to the drawings wherein like parts are designated with like numerals throughout.

The tab appending system disclosed herein overcomes several deficiencies in the technology related to the automatic indexing of documents with customizable tabbed sheets. In the copier or printer technologies, a method and apparatus is not known for providing either on-line tab appending in a copier or printer, or a tabbing system compatible for use with a variety of computer printers and software in a configuration that eliminates the many disadvantages of previously available tabbing methods. What has been needed and heretofore unavailable is an on-line apparatus capable of appending tabs to standard sheets of paper (e.g., 8½×11 or A4), within the standard printing or copying cycle of a photocopier or printer, so that the tab positions within the document can be guaranteed by generating the tabbed sheets using the same sheet source used to print the rest of the document. The tab appending system described here minimizes or eliminates the wasteful, uneconomical, and inefficient attributes of known devices; for example, it is easier to use than previous devices.

In one embodiment, the invention an automatic document indexing system comprising sheet selecting and position registering means, used in conjunction with a printing means providing a stream of sheets in a sheet path, for selecting a printed sheet to be tabbed, and for position registering the selected sheet at a tabbing registration position for tab appending. The means consist of a pair of rollers that press and move the sheet on the sheet path through a copier or printer; one or more motors to move the rollers; a tab cartridge place above the sheet path, and sensors to detect the presence of sheets on their way to the rollers and to detect the presence of tabs at the output of the tab cartridge.

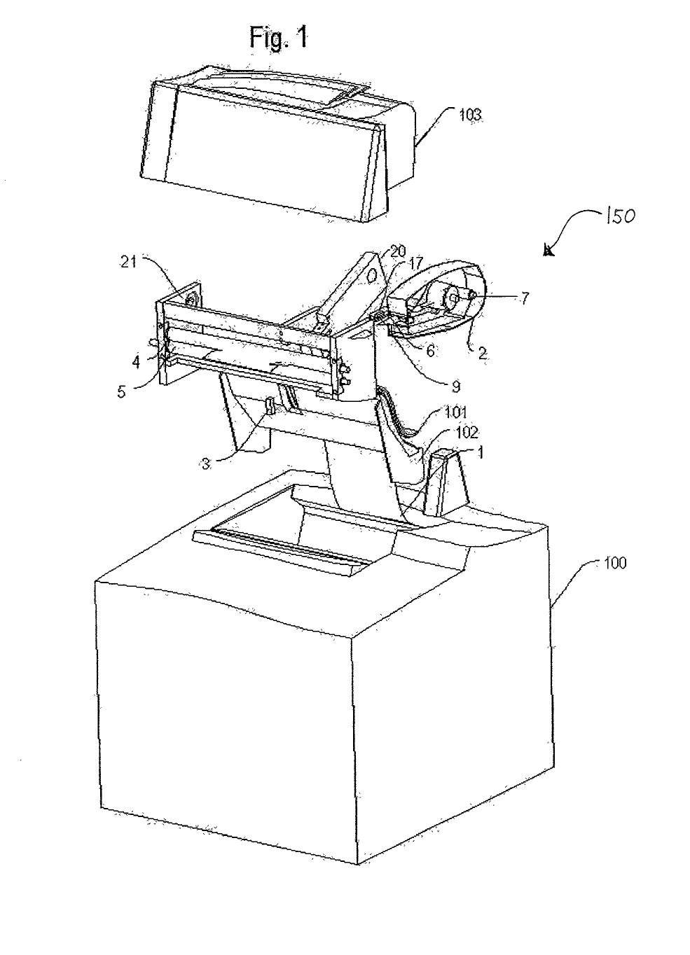

Referring now to the drawings, FIG. 1 shows an exploded, three-dimensional view of the preferred embodiment of the invention. In one embodiment, the tab appending system 150 works in conjunction with a printing device (e.g., a copier or printer) that provides a stream of sheets in a sheet path. The tab appending apparatus is shown here laying above an exemplary printer 100; however, the apparatus can be placed in the paper path of a copier or printer, or over any of the printer's output trays. The tab appending system may be configured to be integrated within a copier or printer, or as part of other paper handling devices. Additionally, the tab appending system may be configured as a separate accessory at the output of a printer or copier. The tab appending system is compatible with various types of computer printing devices including legacy devices, such as laser, inkjet, thermal resistive transfer, custom label, and impact printers in addition to being compatible with many previous, well-known means of printing indicia on tabs such as photocopiers and typewriters.

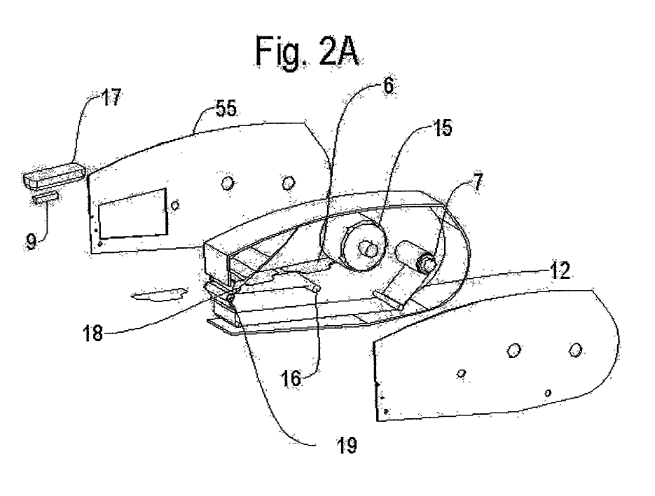

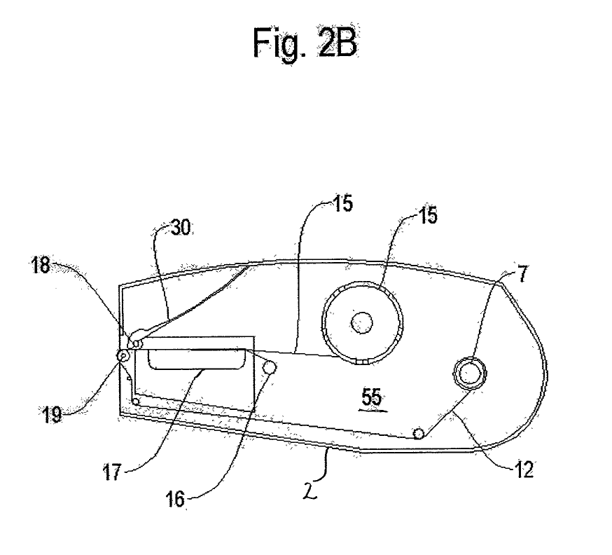

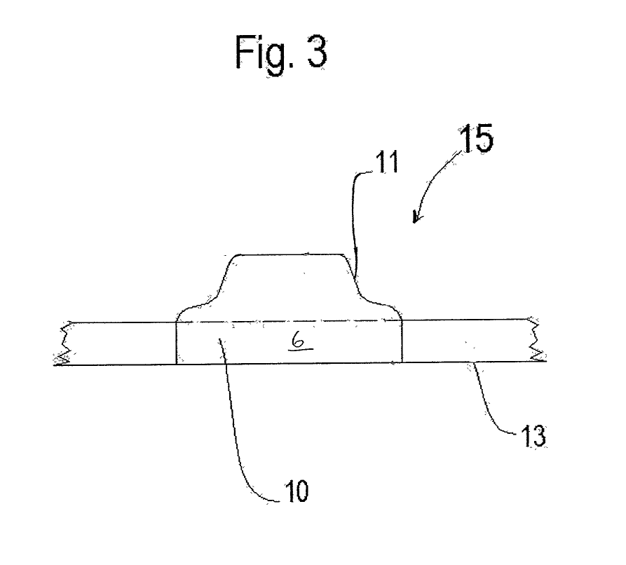

After a sheet 1 leaves the printer or copier, it is guided by the sheet guides 101 and 102 past a sheet sensor 3 to a pair of rollers 4 and 5. These rollers are held in place by a roller chassis 21. The sheet sensor 3 detects the presence of the sheet 1 and turns on the rollers 4 and 5 that guide the sheet. To append a tab 6 to a sheet 1 that has been selected for tabbing, a traction roller 7 contained within a tab cartridge 2 is activated when the desired length of sheet 1 has gone through the rollers 4 and 5. The printer head 17 is placed near the tab 6 and prints the required indicia upon the tab 6, using an ink ribbon 12 (shown in FIG. 2) that releases ink when heated. The tab cartridge 2 is supported by a cartridge support 20. As the tab 6 moves forward, a tab sensor 9 records the passage of the tab 6 and the time it takes for the tab 6 to be printed. This is used to recalibrate the speed of the traction roller 7 to compensate for the backing tape 13 wrapping around the traction roller 7. As the tab 6 is pressed between the tab rollers 18 and 19, a first segment of the tab 6 containing an adhesive material is attached to the sheet 1, leaving a second segment of the tab 6 that has no adhesive protruding from the sheet 1. To facilitate separation of the tab 6, the tab assembly 300 (shown in FIG. 3) is precut to the desired size and shape of each tab 6. The tab traction roller 7 is stopped once the tab 6 is attached to the sheet 1. Since the tab 6 is attached to the sheet 1, which is being pulled by rollers 4 and 5, it separates from the tab cartridge 2. A cover 103 is optionally used to protect the apparatus, as well as for ease of transportation and fitting to printers, copiers and the like.

FIGS. 2A and FIG. 2B show the components of the tab cartridge 2. The tabs 6 are contained in an assembly within a cartridge fitted to the apparatus in a similar manner to that used in conventional ribbon-cartridge printers. The tab cartridge 2 comprises a tab roll 15 having pre-cut tabs held together by a backing tape 13, a tab roller 16 that both provides a path for the tabs affixed to the backing tape 13 and contains the unused portion of the ink ribbon 12, a traction roller 7 for spooling the used portion of the ink ribbon 12, a tab sensor 9, and a print head 17 used to record indicia on each tab 6. In the preferred embodiment of the invention the print head 17 is a thermal print head; however, other print heads such as, for example, inkjet technology, thermal resistive transfer printing, impact printing, or dot matrix printing, may be used to print text or graphics on each tab as it moves towards the tab rollers 18 and 19. The tab cartridge 2 is positioned by sliding it into the cartridge support 20. The tab cartridge 2 has a side 55 provided with an aperture for allowing the print head 17 to enter the tab cartridge 2. Once the tab cartridge 2 is all the way in, it is pressed down and locked into position. As the tab cartridge 2 is pressed down, the print head 17 makes contact with the print ribbon 12.

In one embodiment, the end of the backing tape 13 is held together with the end of the ink ribbon 12 by the traction roller 7. The ink ribbon 12 forms one continuous segment that spools out of the tab roller 16 onto the traction roller 7. When the traction roller 7 is activated, it pulls a length of backing tape 13 with a tab 6 together with the ink ribbon 12 next to it, towards the position where the print head 17 is held. The tabs 6 travel on top of the ink ribbon 12. The print head 17 is heated causing the wax-based ink from the print ribbon 12 to transfer onto the tab 6. The print head 17, located underneath the ink ribbon 12, then prints the desired indicia upon the tab 6 using the ink ribbon 12. This printing technology is commonly used and well known, such as, for example, in facsimile machine technology. Finally, the annotated tab 6 exits the tab cartridge 2 as shown, while the remaining backing tape and used ink ribbon 12 are neatly stored around the traction roller 7.

FIG. 3 shows a detailed view of the tab roll 15 formed by assembling a plurality of tabs 6 onto a backing tape 13. Each tab 6 has a portion 10 that is coated with an adhesive material such as, for example, pressure sensitive glue. The adhesive is formulated to either permanently or releasably adhere to a peripheral edge of a sheet of material which is to be tagged, labeled or indexed. Each tab 6 also comprises a portion 11 that protrudes out of the sheet when appended. The material for each tab 6 is pre-shaped and precut into tabs at predetermined positions and held together by a backing tape 13, which is only as wide as the width of the portion containing the adhesive on each tab 6.

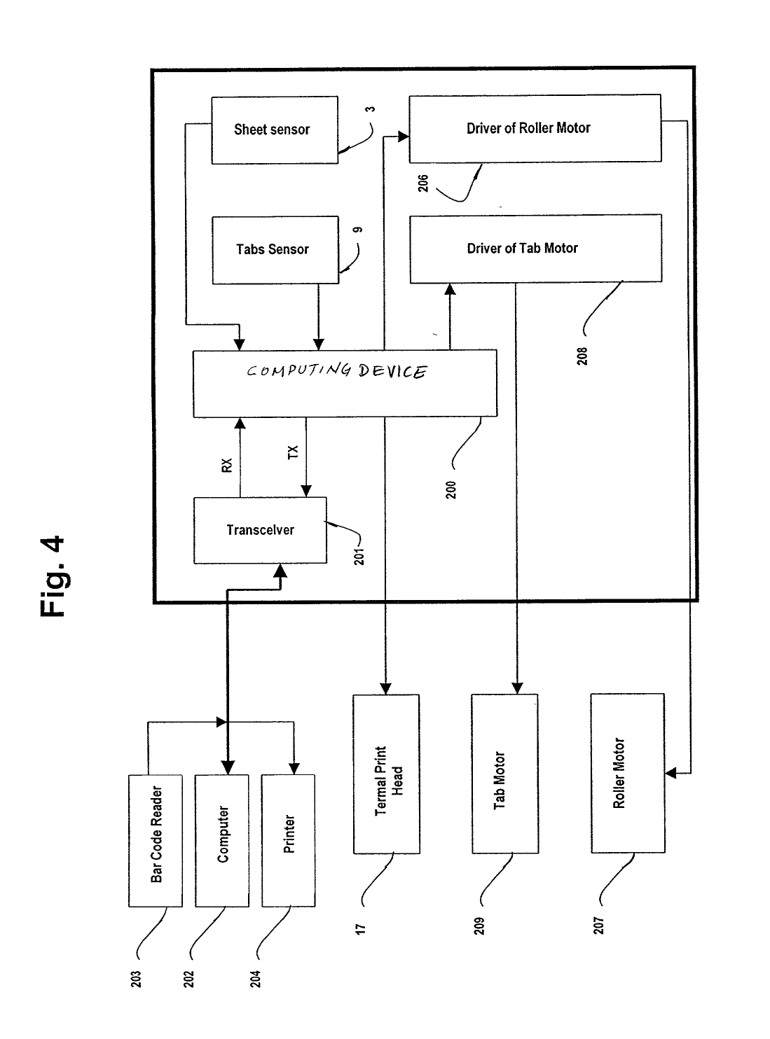

FIG. 4 describes schematically the electronics used together with actuators and feedback sensors required to implement the hardware required by the present invention. In one embodiment, the computing device 200 communicates directly with a host computer 202 via an interface software running on the host computer 202. Communication with the host computer 202 is typically done using an established protocol and a serial or parallel port. The host computer communicates system configuration or instructions regarding tab indicia. The instructions may be provided by text editing or desktop publishing software through the addition of a template, macro or computer driver. The exemplary template can establish communications with the apparatus through the communications port of standard personal computers or a language such as PCL, when the apparatus is directly connected to the printer cabling. In this way, the apparatus will be compatible with various types of printing or copying devices.

In one embodiment, the tab appending system provides the capability of communicating instructions (or system configuration) between a host computer 202 and the tab appending apparatus via a printer 204 with the aid of a transceiver 201. The communication may use a language such as, for example, printer command language (PCL), wherein the instructions are provided by text editing or desktop publishing software utilizing a template, macro or computer driver. When the communication goes through a printer, the application, macro or driver used to specify tab positions and content adds special commands to the printer communication language such as PCL or PostScript. The printer 204 then forwards those commands to the computing device 200 using existing protocols such as HP Clink or HP JetLink. In this manner, the computing device 200 gets information regarding each tab from the interface software.

In an alternative embodiment of the present invention, where there is no direct communication between the interface software and the tab appending system, a bar code reader 203 can be added to the tab appending apparatus, and thereby obtain the information required by the computing device 200, with the aid of a transceiver 201. The bar code can be generated in software, as the document is created, and this bar code can be printed directly on a designated document page, or on the document page where it is to appear, or even formed or printed as a label which can be attached to the sheet where a tab is to be appended. The barcode label can be read by the apparatus and the tab described by the bar code can then be affixed to the selected sheet at a selected position. The details involved in barcode generation and decoding are well known in the relevant technology.

The motors 207 and 208, the tab cartridge 2, and the sensor 3 are connected to a Printed Circuit Board (PCB) having a computing device 200, and other appropriate electronic components. The use of PCBs, computing devices and related electronics is well known in the relevant technology. When the sheet 1 leaves the printer 100, its presence is detected by the sheet sensor 3. Upon receiving the sheet-present signal, the computing device 200 activates the driver of roller motor 206, thereby activating the sheet roller motor 207. The apparatus described here uses the tab specification to calculate the number of steps or the time that it will take for the sheet 1 to reach the selected position under the rollers 4 and 5. At this point, the computing device 200 activates the traction roller 7 contained within the tab cartridge 2 to attach the tab 6. If a sheet 1 is selected to have a tab 6 appended, the tab motor driver 208 is activated, thereby activating tab motor 209, which in turn moves the tab 6 forward by actuating the traction roller 7. When the tab sensor 9 indicates the beginning of a tab 6, the computing device 200 loads the thermal print head 17 with the data to be printed on the tab 6. When the tab sensor 9 indicates the end of the tab 6, it is necessary to recalculate the number of motor steps needed to bring the next tab 6 into the correct position for printing by the print head 17. This recalculation is necessary because the angular and linear velocities, at which the tabs 6 are delivered to the print head 17, vary as the spooled ink ribbon 12 on traction roller 7 accumulates. The number of steps required to move the tab 6 through the print head 17 is estimated through a calibration procedure. The initial number of steps is known since the tab cartridge 2 always has the same initial contents. To attach the tab 6 at the desired registration point, the number of steps, or the time that it takes for the sheet 1 to reach the registration point is calculated. When the position at the selected sheet 1 is reached, the tab motor 209 is briefly activated, moving the tab 6 forward to a position where it is trapped by rollers 4 and 5. The tab 6 is then appended to the selected sheet 1 at the selected position. The sheet roller motor driver 206 is deactivated some time after the sheet sensor 3 is turned off; this allow the sheet 1 to exit the rollers 4 and 5. A preferred embodiment of the electronics employs stepper motors and therefore steps are counted for positioning. However, alternative embodiments can employ direct current motors together with positioning encoders, as is well known in the relevant technology, to achieve the same effect at a lower cost.

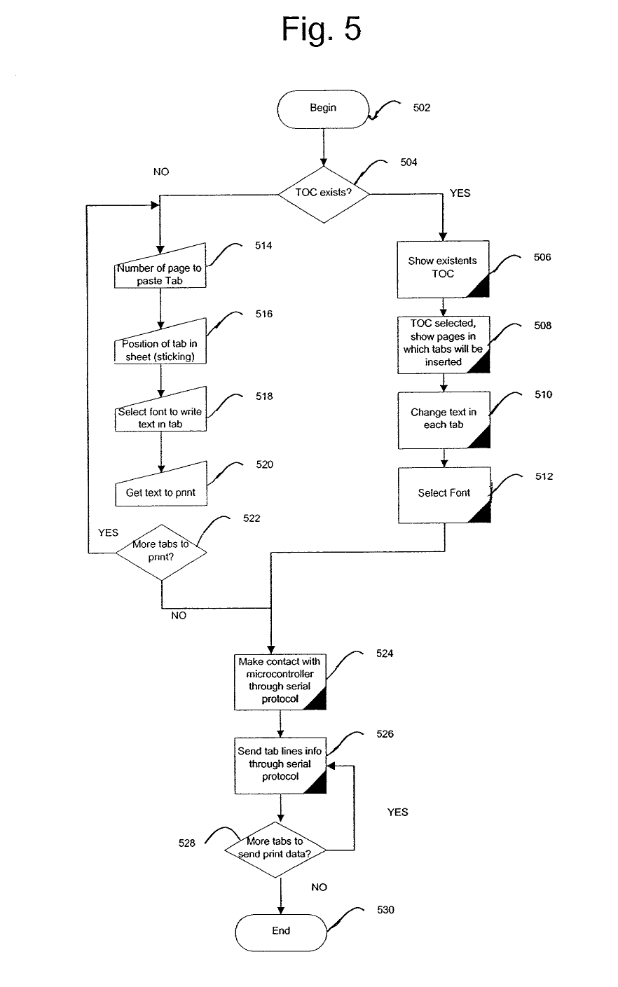

FIG. 5 shows a flow chart of the software system used to interface text editing or desktop publishing software with the tab appending apparatus of the present invention. In the preferred embodiment of the invention, the system is implemented through a template, a macro or a computer driver. The system begins at block 502 by initializing all data structures. The system proceeds to decision block 504 where it checks to see if a “Table of Contents” (TOC) exists. This may be done by checking the file properties, or analyzing the paragraph or heading styles, for example. If a TOC exists, the system displays the contents of the TOC to the user at block 506. Next, the system displays, at block 508, pages where each tab 6 can be appended. The system proceeds to blocks 510 and 512, where the text to be printed on each tab 6 is defined and the font to be used is selected, respectively. If a TOC does not exist, at block 514 the system prompts the user for a page number onto which a tab 6 is to be appended. Next, the system prompts the user, at block 516, for the position where the tab 6 is to be appended. The system proceeds to block 518 where font selection takes place. At the next block 520, the system prompts the user for the text to be printed on the tab 6. Finally, at decision block 522, the system determines whether more tabs are to be printed; if so, the system returns to block 514 to initiate the process again.

When all tabs to be printed have been defined, the system moves to block 524, where the host computer 202 establishes a communication link with the computing device 200. When a sheet is printed, depending on the configuration of the interface software, the software may generate the appropriate PCL commands; alternatively, the interface software may attempt to establish direct communication with the apparatus of the present invention. If communication is established, at block 526 the system sends information to the apparatus regarding the tab 6 to be printed. At decision block 528, the system determines whether all tab information has been sent to the apparatus. If that is not the case, the system returns to block 526. When all tab information has been transmitted, the system ends the process at block 530. The protocols used to pass information between text editing or desktop publishing software, printers, copiers and paper handling devices are well known in the relevant technology. The preferred protocol is a language such as PCL; however, other protocols such as communications protocols currently used by computers or barcode reader/decoder arrangements are also applicable and well known.

In another embodiment, where the invention is not configured to communicate directly with the interface software, the interface software may be configured to generate barcode information defining each tab 6. This barcode information may be printed in the first sheet of the set, or alternatively on each sheet where a tab is to be appended. This maybe the case where a document is printed by a printer and the apparatus described in the present invention is placed downstream of a copier, in which case there is no direct link between the interface software and the apparatus.

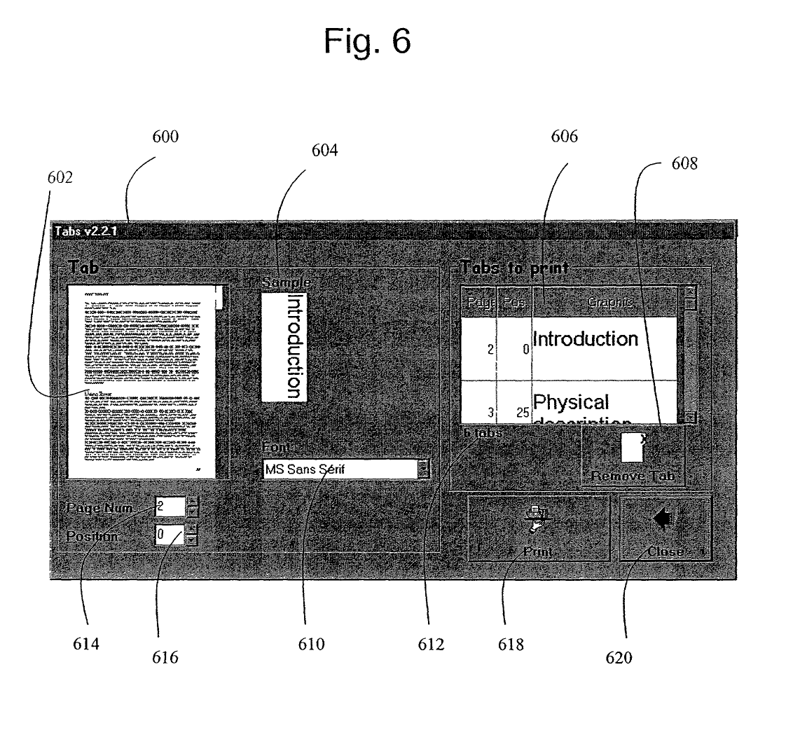

FIG. 6 shows an exemplary user interface 600 for use with the present invention. The user utilizes interface 600 to specify the page (field 614), position (field 616) and content (field 604) that is to be printed on a selected tab 6. This example is implemented on MS-Word using a Word-BASIC macro; however, a person of ordinary skill in the relevant technology will recognize that there are several software implementations and packages that can be used to achieve the same result. In this embodiment, the user interface is a window 600 which the user can bring forward from within MS-Word showing a preview of the document page with the tab appended (field 602), a magnified preview of the tab (field 604), a list of tabs to be printed (field 606), the option to remove a tab (field 608), the font for the text of the tab (field 610), the number of tabs to be printed (field 612), the number of the page to which the tab will be appended (field 614), the position of the tab 6 (field 616), the option to print (button 618) and finally a means to close (button 620) the window.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

What is claimed is:

1. A method of automatically indexing a document comprising:
feeding a plurality of untabbed sheets in the sheet path of a sheet handling device;
identifying selected ones of the sheets based upon a predefined criteria; and
automatically appending a tab to the identified sheets.

2. The method of claim 1, wherein the sheet handling device is a printer or photocopier.

3. The method of claim 1, wherein the sheet path comprises the output receptacle of the sheet handling device.

4. The method of claim 1, wherein automatically appending is performed by a tab appending device controlled by a computing device.

5. The method of claim 4, wherein the computing device is in communication with a central processing unit of a computer that hosts text editing software, or with a printing device, or a bar code reading device.

6. The method of claim 1, further comprising identifying a location on the selected sheet where the tab is to be appended.

7. The method of claim 6, wherein the location of the tab is determined by software after an analysis of the electronic version of the document.

8. The method of claim 6, wherein a user specifies the location of the tab using a software interface.

9. The method of claim 1, further comprising recording indicia on the tab to be appended to the selected sheet.

10. The method of claim 1, wherein one of the predefined criteria is a page number.

11. The method of claim 1, further comprising:
identifying a location for appending the tab to the identified sheet; and
printing indicia on the tab.

12. A method of automatically indexing a document comprising:
feeding a plurality of untabbed sheets in the sheet path of a printing device;
identifying selected ones of the sheets based upon a predefined criteria;
automatically identifying locations for appending tabs to the identified selected sheets;
printing indicia on the tab, wherein the indicia is electronically stored; and
appending the tab to the identified selected sheets.

13. The method of claim 12, wherein the printing device is a printer or a photocopier.

14. The method of claim 12, wherein the sheet path of the printing device comprises the output receptacle of the printing device.

15. The method of claim 12, wherein identifying selected ones of the sheets is performed by a computing device, wherein the computing device is in communication with a central processing unit of a computer that hosts text editing software, or with a printer or photocopier, or with a bar code reading device.

16. The method of claim 12, wherein identifying the location for appending the tab is determined by software analysis of the electronic version of the document.

17. The method of claim 12, wherein the indicia is generated with a software interface configured to allow a user to define or modify at least one characteristic of the indicia.

18. The method of claim 12, wherein one of the predefined criteria is a page number.

19. An apparatus for automatically indexing a document comprising:
a sheet handling device having a sheet path, wherein the document is fed through the sheet path;
a computing device for identifying selected ones of the sheets in the sheet path;
a sheet sensor in communication with the computing device; and
a tab appending mechanism, controlled by the computing device, for appending a tab to the selected sheet.

20. The apparatus of claim 19, wherein the computing device receives instructions from an external computing device having text editing capabilities, or from a printer or photocopier, or from a bar code reading device.

21. The apparatus of claim 19, wherein the tab appending mechanism comprises a tab dispensing mechanism controlled by the computing device.

22. The apparatus of claim 21, wherein the tab dispensing mechanism comprises a roll of pre-cut tabs attached to a backing tape.

23. The apparatus of claim 22, further comprising a device for recording indicia on the tab to be dispensed.

24. The apparatus of claim 23, wherein the device for recording indicia comprises a print head and an ink source.

25. The apparatus of claim 24, wherein the print head is selected from the group comprising: a laser printing device, an ink-jet printing device, a thermal resistive transfer printing device, and an impact printing device.

26. The apparatus of claim 24, wherein the apparatus is integrated with the sheet handling components of a printing device.

27. The apparatus of claim 26, wherein the printing device may be selected from the group comprising: a printer, a photocopier, and a typewriter.

28. The apparatus of claim 24, wherein the apparatus is configured for use as an external accessory for use with a printing device.

29. The apparatus of claim 24, wherein the apparatus is configured for use with the manual feeding of sheets.

30. The apparatus of claim 24, wherein the computing device receives an indication of the location for appending the tab on the selected sheets.

31. The apparatus of claim 30, wherein the indication is provided by a user utilizing a software interface.

32. The apparatus of claim 30, wherein the indication is provided by software analysis of an electronic version of the document.

33. The apparatus of claim 24, wherein a user utilizes software configured to allow creation and modification of the indicia.

34. An apparatus for automatically indexing a document comprising:
a printing device having a sheet path for delivering a document having printed, untabbed sheets;
a sheet sensor for detecting sheets in the sheet path of the printing device;
a computing device, in communication with the sheet sensor, identifying selected ones of the printed, untabbed sheets;
a tab dispensing device, controlled by the computing device, for appending tabs to the identified selected sheets; and
a print head, controlled by the computing device and cooperating with the tab dispensing device, for recording indicia on the tabs.

35. An apparatus for automatically indexing a document comprising:
a printing device;
means for detecting sheets in the output path of the printing device;
means for identifying selected ones of the sheets for receiving a tab, wherein the identifying means communicates electronically with the detecting means;
means for indicating locations where the tabs are to be appended to the selected sheets, and for creating and editing indicia to be recorded on the tabs;
means for generating and communicating the location and indicia of the tabs to the selecting means;
means for recording the indicia on the tabs, wherein the selecting means controls the recording means; and
means for appending the tabs to the selected sheets, wherein the selecting means controls the appending means.
